(19) United States
(12) Patent Application Publication
(10) Pub. No.: US 2012/0136848 A1
(43) Pub. Date: May 31, 2012

(54) INFORMATION PROCESSING APPARATUS CAPABLE OF PROVIDING ADVANCED TEXT SEARCH

(75) Inventor: Tomohiro Hanyu, Ome-shi (JP)

(73) Assignee: KABUSHIKI KAISHA TOSHIBA, Tokyo (JP)

(21) Appl. No.: 13/367,885

(22) Filed: Feb. 7, 2012

Related U.S. Application Data
(63) Continuation of application No. 12/117,891, filed on May 9, 2008, now abandoned.

(30) Foreign Application Priority Data
Aug. 23, 2007 (JP) 2007-217356

(51) Int. Cl. G06F 17/30

(52) U.S. Cl. 707/706; 707/E17.014

(57) ABSTRACT

An information processing apparatus that includes a pointing device for moving a cursor to a position on a display screen; a monitoring unit that monitors whether or not the pointed position is stationary for a predetermined time period; and a text extraction unit that determines a character displayed on the pointed position and extracts a target text portion that includes the pointed to character. A text analysis unit generates a search keyword that is suitable for performing a search operation, based on analysis of the target text portion, generates an attribute representing a subject category, based on the search keyword, and generates a search intention item representing intended subject content to be searched, based on the attribute; and a display controller that controls the display of an overlayed search window menu that facilitates selection of the search keyword and/or the search intention item for a search operation.

### CROSS-REFERENCE TO RELATED APPLICATIONS

This application is a continuation of co-pending U.S. application Ser. No. 12/117,891 filed May 9, 2008, and for which priority is claimed under 35 U.S.C. §120. This application is based upon and claims the benefit of priority under 35 U.S.C. §119 from the prior Japanese Patent Application No. 2007-217356, filed on Aug. 23, 2007, the entire content of both applications are incorporated herein by reference in their entireties.

### BACKGROUND

1. Field

One embodiment of the invention relates to an information apparatus that allows a user to effectively enter a keyword appropriate for performing a search with a search engine, the keyword being extracted from a displayed document, and relates to a user interface therefor.

2. Description of the Related Art

A search engine that is useable at no charge has been developed centering on the Internet. The search engine enables a user to access various pieces of information existing on the Internet.

However, as the Internet is flooded with a wide variety of pieces of information with an increase in the population of accessing the Internet, convenience with the search engine backfires and it is becoming difficult to reach the target information. To use the search engine, it became more important to select an appropriate keyword for performing the search to reach desired information.

There is proposed a service intended for contributing to the convenience for a viewer to make a search by providing a keyword relevant to a broadcast program together with the broadcast program so as to enable the viewer to access information concerning the broadcast program from the Internet. An example of such service is disclosed in JP-A-2004-086754.

The prevalence of the search engine has made it possible for a user to easily access various pieces of information. However, a situation also occurs in which it is difficult to reach the target information because of being awash in a sea of information on the Internet.

### SUMMARY

According to a first aspect of the present invention, there is provided an information processing apparatus that displays text on a display device, the apparatus including: a pointing device that allows a user to move a cursor displayed on the display device to point to a position in a display screen of the display device; a monitoring unit that monitors whether or not the pointed position is unmoved for a predetermined time period; a text extraction unit that, when determined that the pointed position is unmoved for the predetermined time period, determines a character displayed on the pointed position and extracts a target text piece having a predetermined length and including the character from the displayed text; a text analysis unit that (1) adjusts the text string that exists near the character into a search keyword that is suitable for performing a search by analyzing the target text and (2) outputs a search intention item that indicates a subject to be searched regarding the search keyword based on an attribute of the search keyword; and a display controller that controls the display device to display a search menu that allows the user to select at least one of the search keyword and the search intention item.

According to a second aspect of the present invention, there is provided a method for allowing a user to input a specific string in a document displayed on a display device as a search keyword that is suitable for performing a search, the method including: allowing the user to move a cursor displayed on the display device to point to a position in a display screen of the display device; monitoring whether or not the pointed position is unmoved for a predetermined time period; determining, when determined that the pointed position is unmoved for the predetermined time period, a character displayed on the pointed position; extracting a target text piece having a predetermined length and including the character from the displayed text; adjusting the text string that exists near the character into a search keyword that is suitable for performing the search by analyzing the target text; outputting a search intention item that indicates a subject to be searched regarding the search keyword based on an attribute of the search keyword; and controlling the display device to display a search menu that allows the user to select at least one of the search keyword and the search intention item.

According to a third aspect of the present invention, there is provided a computer-readable storage medium that stores a computer program that causes a computer to perform a process for allowing a user to input a specific string in a document displayed on a display device as a search keyword that is suitable for performing a search, the process including: allowing the user to move a cursor displayed on the display device to point to a position in a display screen of the display device; monitoring whether or not the pointed position is unmoved for a predetermined time period; determining, when determined that the pointed position is unmoved for the predetermined time period, a character displayed on the pointed position; extracting a target text piece having a predetermined length and including the character from the displayed text; adjusting the text string that exists near the character into a search keyword that is suitable for performing the search by analyzing the target text; outputting a search intention item that indicates a subject to be searched regarding the search keyword based on an attribute of the search keyword; and controlling the display device to display a search menu that allows the user to select at least one of the search keyword and the search intention item.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a drawing to show an example of an information processing apparatus according to an embodiment of the present invention.

FIG. 2 is a block diagram to show a configuration example of the information processing apparatus according to the embodiment.

FIG. 3 is a block diagram to show an example of the functions of the information processing apparatus according to the embodiment.

FIG. 4 is a drawing to show a screen display example according to the embodiment.

FIG. 5 is a drawing to show another screen display example according to the embodiment.

FIG. 6 is a drawing to show another screen display example according to the embodiment.

FIG. 7 is a flowchart to show an example of a keyword search flow according to the embodiment.

### DETAILED DESCRIPTION

Referring now to the accompanying drawings, there is shown an embodiment of the present invention.

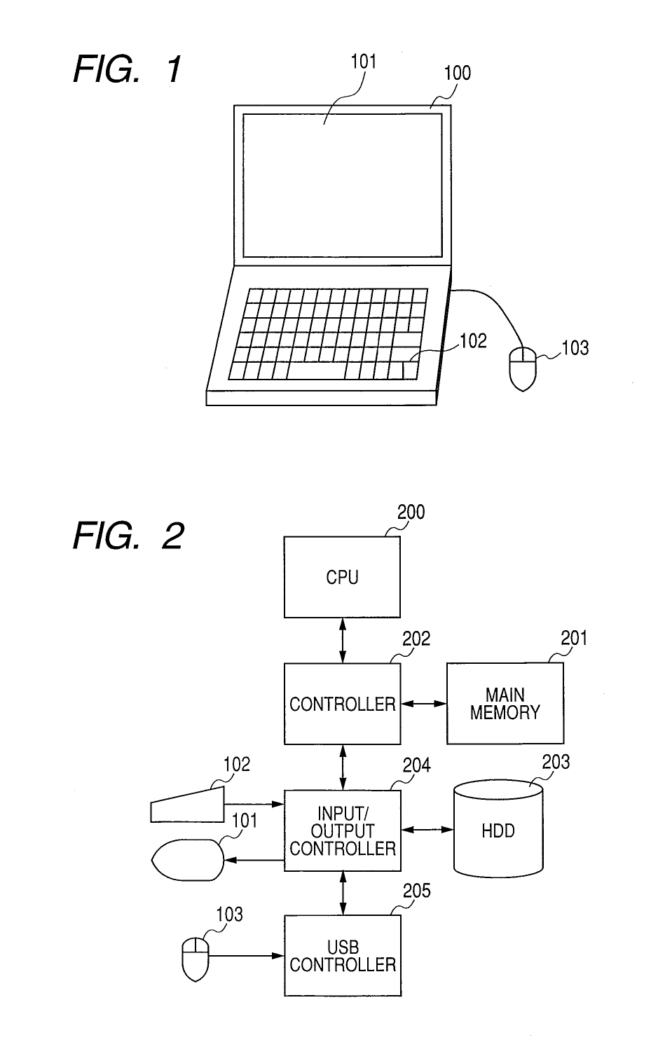

FIG. 1 is a drawing to show an example of an information processing apparatus according to an embodiment of the present invention. FIG. 1 shows a PC 100, a display 101, a keyboard 102, and a mouse 103.

The PC 100 is a portable personal computer such as a notebook personal computer.

The display 101 is a display installed in the PC 100. For example, the display 101 may be an LCD (Liquid Crystal Display) for the PC 100 to display information for the user.

The keyboard 102 is an input unit built in the PC 100. The user of the PC 100 inputs command with a keystroke of the keyboard 102.

The mouse 103 is an input unit for the user to move a mouse cursor displayed on a screen of the PC 100 as the user intends. Such an input device is also called a pointing device because it is used to point out a predetermined part on the screen. Further, the mouse 103 also includes several buttons for giving a start command of predetermined operation to the PC 100.

FIG. 2 is a block diagram to show a configuration example of the PC 100 according to the embodiment of the invention. It shows a CPU 200, main memory 201, a bus controller 202, an HDD 203, an input/output controller 204, and a USB controller 205.

The CPU 200 is a central processing unit for controlling the whole information machine 100. It has a function of executing a program and performing predetermined processing responsive to the program.

The main memory 201 is implemented as semiconductor memory and is used as a program and data storage area for the CPU 200 to process a program.

The bus controller 202 has a function of controlling a bus for transferring information between the components of the information machine 100. According to a command output from the CPU 200, the bus controller 202 read and writes data in the main memory 201 and transfers a command to other devices via the bus.

The HDD 203 is large-capacity storage implemented as a magnetic disk drive (hard disk drive), for example. The HDD 203 stores an application program executed by the CPU 200 and data used when executing the application program, and passes the application program and data to the CPU 200 through the bus controller 202.

The input/output controller 204 serves as an interface for the CPU 200, the HDD 203, and various input/output units of the display 101, the keyboard 102, etc.

The USB controller 205 is a controller for connecting a machine having a USB (Universal Serial Bus) standard interface. Various machines conforming to the USB standard come on the market and can be connected and disconnected as desired according to PnP (Plug and Play) even if the information machine 100 is operating.

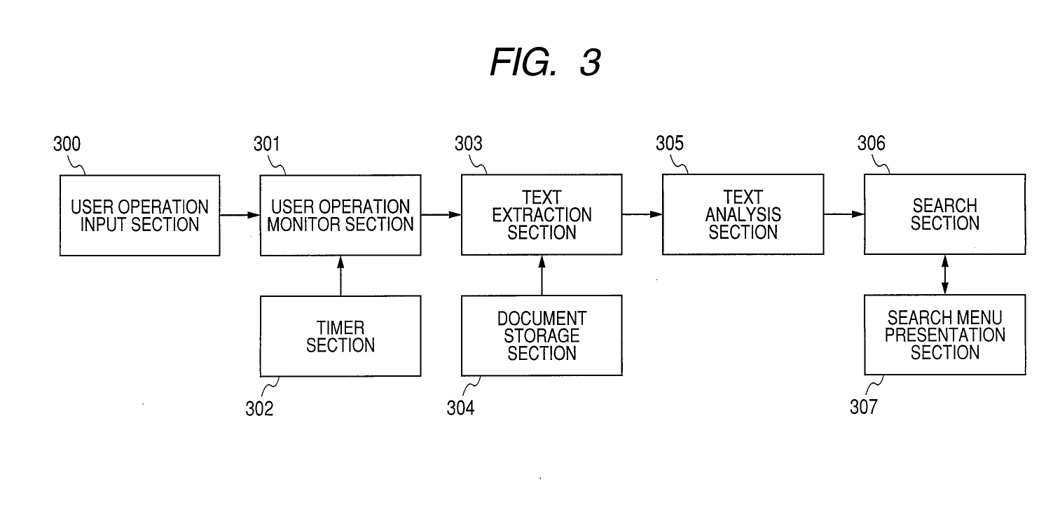

FIG. 3 is a block diagram to show an example of the functions of the information processing apparatus according to the embodiment. FIG. 3 shows a user operation input section 300, a user operation monitor section 301, a timer section 302, a text extraction section 303, a document storage section 304, a text analysis section 305, a search section 306, and a search menu presentation section 307. In the embodiment, the functions are implemented as processing of applications stored in the HDD 203 and the components of the information processing apparatus 100 cooperate.

The user operation input section 300 has a function of accepting user operation from the keyboard 102 and the mouse 103 and converting the operation into input operation. For example, the input information is pointing information of the mouse 103 and a mouse cursor can be displayed at the pointed-to position of the display 101.

The user operation monitor section 301 includes a monitor function of checking whether or not the operation accepted in the user operation input section 300 contains predetermined operation. The operation is acquired as a notification of a message defined in the applications and an OS (Operating System). In the embodiment, the user operation monitor section 301 monitors no move operation of the mouse cursor displayed on the display 101 with the mouse 103 having been performed for a predetermined time.

The timer section 302 has a function of counting a predetermined time period. In the embodiment, a predetermined time period is counted and when the time period expires, a message is sent out. The user operation monitor section 301 uses the message to measure the predetermined time in monitoring the user operation.

The text extraction section 303 has a function for extracting text starting at the character string displayed at the position of the mouse cursor on the display 101 when the user operation monitor section 301 detects that a monitor condition is satisfied. Usually, the mouse cursor of the mouse 103 as the pointing position is given as (X, Y) coordinates on the display 101. For example, the coordinates are converted into the character position in the document file displayed on the window at which the mouse cursor exists. After the conversion, as many characters as a predetermined number of characters preceding and following the character position can be extracted.

The document storage section 304 is a storage that stores the document file on the window displayed on the display 101. Usually, the text displayed on a window is only a part of the whole document and thus the text extracted by the text extraction section 303 is acquired based on the document file in the document storage section 304 storing the whole document. In the embodiment, the document storage section 304 is reserved in the HDD 203.

The text analysis section 305 includes a function of analyzing whether or not the character string existing at the character position is a character string suited for the search from the text extracted in the text extraction section 303 and information of the character position pointed to by the mouse cursor. To use a conventional search engine, etc., the user must clearly specify the search word, for example, in such a manner that the user drags and highlights the search word range. This operation is difficult for the user unfamiliar with mouse operation, and operation mistakes easily occur. Since the search operation is entrusted to the user, it is often possible to find a search keyword not suited for the search.

The analysis function allows the user to simply specify the character string at the specification position, whereby a keyword as an effective character string for user-desired search centering on the character string can be extracted considering the context preceding and following the keyword. If an effective character string as a search keyword cannot be extracted, for example, if the character string is determined a character string not suited for a search keyword because a significant result cannot be provided even if a search is made using an excessively general name, a message indicating an invalid search request can also be returned.

An example of a technology for performing the analysis described above is described in detail in JP-A-2006-065754. Therefore, the detail of the analysis will be omitted herein. In the embodiment, an analysis program created using the technology is referred to as the knowledge engine. The knowledge engine provides not only a search keyword, but also the attribute suggested from the keyword (which will be hereinafter referred to as meaning category) and the search purpose thought from the attribute (which will be hereinafter referred to as the search intention).

The knowledge engine eliminates the need for the user to exactly select a search character string and provide a search keyword suited for the search.

The search section 306 provides a function to make a search using the search engine. Specifically, it creates a search query and sends a search request to the search engine.

The search menu presentation section 307 presents a search keyword provided by the knowledge engine acquired from the text analysis section 305, a meaning category thought from the keyword, and a search intention predicated on the category to the user. If a plurality of search purposes are possible for the keyword extracted by the knowledge engine, for example, a popup window is displayed for requesting the user to select the intention to make a search final. Information of the user's search intention acquired through the popup window is transmitted to the search section 306 and is reflected on the search query.

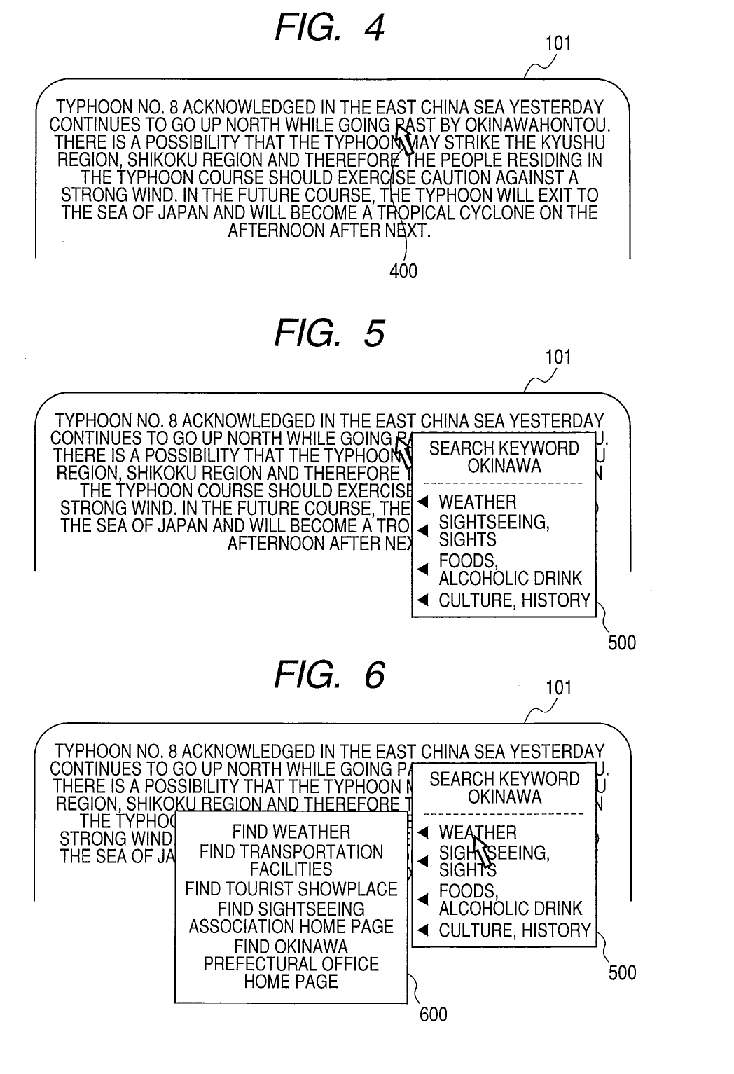

FIG. 4 is a drawing to show a screen display example according to the embodiment of the invention. In FIG. 4, text of a part of a document file is displayed on the display 101 and further a mouse cursor 400 is displayed on the text. The user wants to search for information concerning “OKINAWA” and sets the mouse cursor 400 to the place of “OKINAWA” in the text. At this time, the user does not indicate word separation intentionally, because if the user wants to make a search using a keyword of “OKINAWA” vaguely, whether or not the keyword is suited for the search engine is unknown, and operability for allowing the user to set the mouse cursor 400 to the attention character string without performing selection operation of the character string range is provided.

FIG. 5 is a drawing to show another screen display example according to the embodiment of the invention. If the user leaves the mouse cursor 400 on “OKINAWA” for several seconds counted by the timer section 302, the text extraction section 303 extracts text of several ten characters centering on “OKINAWA” and sends the text to the text analysis section 305. How many characters are to be extracted may be determined considering analysis accuracy and the processing capability of the information processing apparatus 100.

The text analysis section 305 passes the search keyword (here, “OKINAWA”), the meaning category, and the search intention extracted by the knowledge engine to the search menu presentation section 307 through the search section 306. The search menu presentation section 307 first displays a meaning category menu 500 made up of the extracted search keyword and meaning category on the display 101 as a popup window. To extract a word from text where Kanji and Kana characters are mixed, it is considered that “OKINAWAHONTOU” will be often extracted as one word; here, however, the knowledge engine extracts “OKINAWA” as the first place considering semantic interpretation and generalization degree by way of example. If the knowledge engine determines that a character string created by concatenating the character strings preceding and following “OKINAWA, ” for example, “OKINAWAHONTOU” is more appropriate for the search keyword in consonance with the user's intention, “OKINAWAHONTOU” may be extracted as the first place. Although the keyword taking the first place is used in the embodiment, if a plurality of keyword candidates are provided, an additional keyword selection menu may be provided for requesting the user to select a keyword.

Upon reception of extraction of the keyword “OKINAWA,” the knowledge engine provides four meaning categories for the word in the example. Essentially, “OKINAWA” indicates a place name and if a simple search is made, a large number of search results concerning the place name should be able to be obtained. However, the knowledge engine determines that the user takes an interest in the weather of the specified region from the context, and presents the meaning category of “WEATHER” as the first place. In the display of the popup window presented here, the number of meaning categories and the display order change where appropriate based on the extracted search keyword and the context of the extracted text.

Thus, a significant search character string is extracted and the context is considered, so that the user can be guided so that he or she can make a precise search as intended.

FIG. 6 is a drawing to show another screen display example according to the embodiment of the invention.

If the user selects “WEATHER” by moving the mouse cursor 400 onto the meaning category menu 500 or in another manner, a search intention menu 600 for presenting search intentions relevant to “WEATHER” of the search keyword “OKINAWA” is displayed as a popup window.

FIG. 6 shows an example containing five items of “LOOK AND SEE WEATHER, ” etc., provided from the knowledge engine as an illustration of the search intentions. They illustrate for the user what purpose the search is to be made for if the search keyword “OKINAWA” means the meaning category “WEATHER.” An auxiliary search keyword suited for the search intention is additionally provided for each item of the search intention menu and is used when the search section 306 creates a search query.

In so doing, the user can accomplish a precise search in consonance with the search intention by performing simpler operation and selecting an item of the popup window presented by the information processing apparatus 100.

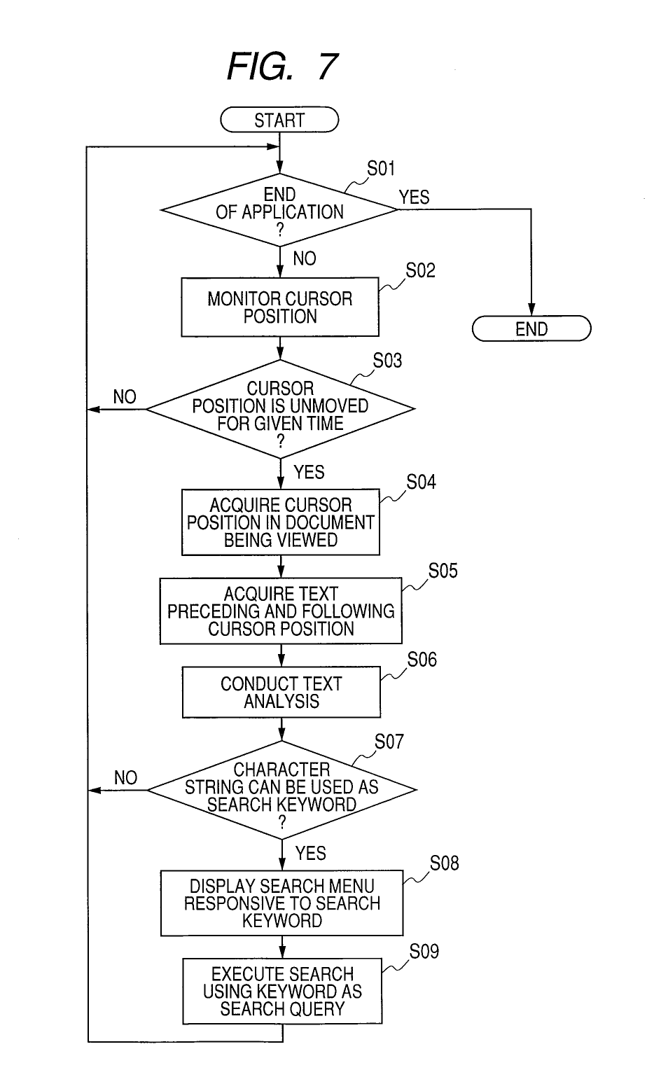

FIG. 7 is a flowchart to show an example of a keyword search flow according to the embodiment of the invention.

To begin with, whether or not the application for making a search using the user interface according to the embodiment receives a quit command is determined (step S01).

Since it is considered that the user interface of the embodiment is often installed as a partial function of the application such as an add-in, if a quit command of the application is given (YES), the user interface is also quitted accordingly.

If a quit command is not given (NO), the user operation monitor section 301 monitors the position of the mouse cursor 400 on the application (step S02). Whether or not the mouse cursor 400 is left at a fixed position for a given time is determined as a result of the monitoring (step 03).

If the position of the mouse cursor 400 is unmoved for the given time (YES), it is determined that a search start trigger concerning the character string pointed to by the mouse cursor 400 is given from the user. The determination of the time period in which the mouse cursor is unmoved, hereinafter referred to as “cursor unmoved-time period”, is made depending on the time count result of the timer section 302. The cursor unmoved-time period needs to be set to an appropriate time; if the time is too short or too long, operability of the user is impaired. Empirically, it is desirable that the time should be set in the range of several seconds.

Next, which character (n-th character from top) in the document file being displayed on the display 101 corresponds to position information indicated by the (X, Y) is calculated and is acquired (step S04). As a simple method, the number of the character in the upper left corner of the text being displayed on the screen counted from the first character in the document file is calculated, and the target character (the number “n”) is calculated by the number of characters displayed in a lateral direction and [X-th column; Y-th row] where the cursor is positioned with the number of the character in the upper left corner.

When the position of the mouse cursor 400 corresponding to the document file is obtained, the text s extraction section 303 extracts text of several ten characters preceding and following the cursor position from the document file (step S05). As the number of extracted characters, all text maybe extracted if analysis accuracy is required; however, since the processing cost increases, the number of extracted characters may be several ten characters to several hundred characters.

The extracted text is sent to the text analysis section 305 and is input to the knowledge engine together with the position of the character string pointed to by the mouse cursor 400, whereby a text analysis is conducted (step S06).

Next, whether or not the specified character string can be used as a search keyword is determined based on the analysis result of the knowledge engine (step S07). If the specified character string cannot be used as a search keyword because of a general word, etc., (NO), the search flow based on the character string is canceled without presenting a meaning category menu or a search intention menu.

When the specified character string can be used as a search keyword (YES at step S07), the search menu presentation section 307 displays a meaning category menu and a search intention menu provided from the knowledge engine together with the search keyword (step S08). The user may select an item matching the essential search intention out of the menus.

Next, the search section 306 creates a search query from the search keyword presented at step S08 and the meaning category and the search intention selected by the user, and sends a search request to the search engine (step S09). If an appropriate search query varies depending on the search engine, a query suited for the search engine is created. The search query contains “search keyword”+“keyword provided from knowledge engine together with selected meaning category”+“keyword provided from knowledge engine together with selected search intention.”

As described above, there is provided a user interface that generates a keyword suited for a search and make a precise search as the user performs more simple operation and selects an item presented by the information processing apparatus 100.

It is to be understood that the present invention is not limited to the specific embodiment described above and that the present invention can be embodied with the components modified without departing from the spirit and scope of the claimed invention. The present invention may be embodied in various forms according to appropriate combinations of the components disclosed in the embodiment described above. For example, some components may be deleted from all components shown in the embodiment. Further, the components in different embodiments may be used appropriately in combination.

What is claimed is:

1. An information processing apparatus, comprising:
a display device having a display screen that is configured to display a document;
an input device that receives a positional information of a pointer that points to a desired position of the displayed document;
a monitoring unit that monitors whether or not the pointed to desired position of the displayed document remains stationary for a predetermined time period;
a text analysis unit configured to:
(a) analyze a target text portion;
(b) generate a search keyword that is suitable for performing a search operation, based on the analyzed extracted target portion;
(c) generate an attribute representing a subject category, based on the generated search keyword; and
(d) generate a search intention item representing an intended subject content for the search operation, based on the generated attribute; and
a display controller that controls the display device to display an overlaid search window menu that facilitates selection of the generated search keyword, the represented subject category, and the generated search intention item for the search operation.

2. The information processing apparatus according to claim 1, wherein the input device comprises a pointing device that controls movement of a cursor displayed on the display screen, the cursor serving as the pointer.

3. The information processing apparatus according to claim 1 further comprising:
a text extraction unit that, when the monitoring unit determines that the pointed to desired position of the displayed document is stationary for the predetermined time period, determines a character of the displayed document pointed to by the pointer and extracts a target text portion that is near the determined character of the displayed document pointed to by the pointer, the extracted target portion having a predetermined length and includes the determined character of the displayed document pointed to by the pointer.

4. The information processing apparatus according to claim 1, wherein the text extraction unit extracts the target text portion to include characters existing before and after the determined character of the displayed document pointed to by the examiner.

5. The information processing apparatus according to claim 1, wherein the text analysis unit outputs a plurality of the generated search keywords, the represented subject category, and a plurality of the generated search intention items with an associated ranking for each of the generated search keywords, the represented subject category, and the generated search intention items; and
wherein the display controller controls the display device to display the overlaid search window menu in a format in which each of the generated search keywords, the represented subject category, and the generated search intention items are to sequentially presented and selectable based on the associated ranking for each.

6. A method of searching for content based on a document displayed on a display device, the method comprising:
receiving a positional information of a pointer that points to a desired position of the displayed document;
monitoring whether or not the pointed to desired position of the displayed document remains stationary for the predetermined time period;
determining, when the pointed to desired position of the displayed document remains stationary for a predetermined time period;
determining, when the pointed to desired position of the displayed document has remained stationary for the predetermined time period, a character of the displayed document pointed to by the pointer;
analyzing a target text portion;
generating a search keyword that is suitable for performing a search operation, based on the analyzed extracted target text position;
generating an attribute representing a subject category, based on the generated search keyword;
generating a search intention item representing an intended subject content for the search operation, based on the generated attribute; and
controlling the display device to display an overlaid search window menu that facilitates selection of the generated search keyword, the represented subject category, and the generated search intention item for the search operation.

7. The method according to claim 6, wherein the target text position is extracted to include characters existing before and after the determined character of the displayed document pointed to by the pointer.

8. The method according to claim 6, wherein a plurality of the generated search keywords, the represented subject category, and a plurality of the generated search intention items are generate with an associated ranking for each of the generated search keywords, the represented subject category, and the generated search intention items; and
wherein the display device is controlled to display the overlaid search window menu in a format in which each of the generated search keywords, the represented subject category, and the generated search intention items are sequentially presented and selectable based on the associated ranking for each.

9. A non-transitory computer-readable storage medium that stores a computer program that causes a computer to perform a process of searching for content based on a document displayed on a display device, the process comprising:
receiving a positional information of a pointer that points to a desired position of the displayed document;
monitoring whether or not the pointed to desired position of the displayed document remains stationary for a predetermined time period;
determining, when the pointed to desired position of the displayed document has remained stationary for the predetermined time period, a character of the displayed document pointed to by the pointer;
analyzing a target text portion;
generating a search keyword that is suitable for performing a search operation, based on the analyzed target text portion;
generating an attribute representing a subject category, based on the generated search keyword;
generating a search intention item representing an intended subject content for the search operation, based on the generated attribute; and
controlling the display device to display an overlaid search window menu that facilitates selection of the generated search keyword, the represented subject category, and the generated search intention item for the search operation.

10. The non-transitory computer-readable storage medium according to claim 9, wherein the target text portion is extracted to include characters existing before and after the determined character of the displayed document pointed to by the pointer.

11. The non-transitory computer-readable storage medium according to claim 9, wherein a plurality of the generated search keywords, the represented subject category, and a plurality of the generated search intention items are generated with an associated ranking for each of the generated search keywords, the represented subject category, and the generated search intention items; and
wherein the display device is controlled to display the overlaid search window menu in a format in which each of the generated search keywords, the represented subject category, and the generated search intention items are sequentially presented and selectable based on the associated ranking for each.
